(19) United States
(12) Patent Application Publication
(10) Pub. No.: US 2024/0410434 A1
(43) Pub. Date: Dec. 12, 2024

(54) ELECTROMECHANICAL BRAKE

(71) Applicant: Robert Bosch GmbH, Stuttgart (DE)

(72) Inventors: Dietmar Kratzer, Tamm (DE); Andrej Gardt, Abstatt (DE); Bernd Lutz, Kempten (DE); Janos Tamas Csoti, Erligheim (DE); Mark Boehm, Lehrensteinsfeld (DE); Martin Winkler, Sonthofen (DE)

(21) Appl. No.: 18/664,626

(22) Filed: May 15, 2024

(30) Foreign Application Priority Data
Jun. 6, 2023 (DE) 10 2023 205 262.8

(51) Int. Cl. F16D 65/18; F16D 65/00; F16D 121/24; F16D 125/40

(52) U.S. Cl. CPC F16D 65/18; F16D 65/0068; F16D 2121/24; F16D 2125/40

(57) ABSTRACT

An electromechanical brake for a motor vehicle. The electromechanical brake includes a brake caliper forming a housing, in which is arranged a spindle drive that is drivable via a drive motor so that a brake piston is movable for applying an axial braking force. The brake caliper is formed in one piece and forms not only an axial support for the spindle drive but also a caliper body so that the braking force and a supporting force counteracting the braking force are absorbed by the brake caliper.

### CROSS REFERENCE

The present application claims the benefit under 35 U.S.C. § 119 of German Patent Application No. DE 10 2023 205 262.8 filed on Jun. 6, 2023, which is expressly incorporated herein by reference in its entirety.

### FIELD

The present invention relates to an electromechanical brake for a motor vehicle. Such an electromechanical brake comprises a brake caliper forming a housing, in which is arranged a spindle drive that is drivable via a drive motor so that a brake piston is movable for applying an axial braking force.

### BACKGROUND INFORMATION

Usually, the service brake is a brake that uses brake fluid to press a brake piston together with a brake pad onto a brake disk in order to brake the vehicle. In the course of the increasing electrification of units in the motor vehicle, the service brake is also to be designed as an electromechanical brake so that brake fluid and the associated complex valve and line structure can be dispensed with. The maintenance effort could also be significantly reduced by such an electromechanical brake.

European Patent No. EP 1 030 979 B1 describes an electromechanical brake device for braking a motor vehicle wheel. The brake device comprises a brake caliper in which an electric motor is arranged. The electric motor drives a spindle drive unit, via which brake pads arranged on a caliper body of the brake caliper are appliable for braking to a brake disk.

An object of the present invention is to specify an electromechanical brake for a motor vehicle that is optimized in terms of production costs and weight.

The object may be achieved by an electromechanical brake with features of the present invention. Preferred example embodiments of the present invention are disclosed herein.

### SUMMARY

The present invention provides an electromechanical brake for a motor vehicle. The electromechanical brake comprises a brake caliper forming a housing, in which is arranged a spindle drive that is drivable via a drive motor so that a brake piston is movable for applying an axial braking force. The brake caliper is formed in one piece and forms not only an axial support for the spindle drive but also a caliper body so that the braking force as well as a supporting force counteracting the braking force are absorbed by the brake caliper.

According to an example embodiment of the present invention, the brake caliper forms a housing. The housing is preferably formed as a bore in the brake caliper. As a result, there is no need to fasten a separate housing to the brake caliper so that the weight for fastening means and a connection interface can be saved. Due to the one-piece design of the brake caliper, there is also no need for fastening means for connecting the different brake caliper parts. Force transmission in the brake caliper is thereby improved. In particular, a material reinforcement in the connection region can be dispensed with so that material is also saved here.

According to an example embodiment of the present invention, the axial support for the spindle drive is also formed by the one-piece brake caliper. Accordingly, connecting means for a separate support element can also be dispensed with here. Due to the corresponding design of the brake caliper, the braking forces, which are absorbed by the caliper body, and the supporting forces of equal magnitude but opposite direction, which are absorbed by the axial support, are completely absorbed by the brake caliper. Only a single component must therefore be produced. Overall, production costs and weight for the electromechanical brake are thus reduced. Additional working steps for attaching an axial support are saved.

In a preferred example embodiment of the present invention, the caliper body of the brake caliper has a cutout, via which the spindle drive and the brake piston are insertable into the housing formed by the brake caliper. A cutout in the caliper body has the advantage that the spindle drive and the brake pistons are easier to insert into the housing of the brake caliper via this cutout. Assembly of the electromechanical brake is thereby simplified.

In a further preferred example embodiment of the present invention, the brake caliper forms an anti-rotation lock for the spindle drive. Thus, no further parts and associated connection elements are necessary to form an anti-rotation lock.

Preferably, the anti-rotation lock is formed in the form of a slot in the brake caliper.

Preferably, at least one separate inner part, via which at least one anti-rotation lock for the spindle drive is formed, is inserted into the brake caliper. By forming a separate part as an anti-rotation lock, the production of the anti-rotation lock is simplified. An undercut, which is difficult to form on the brake caliper, can thereby be avoided. It is thereby also possible to use a material for the anti-rotation lock that is different from the brake caliper. Since such an anti-rotation lock does not have to absorb high forces, a less solid material can be used, which is moreover lighter. It is also possible, for example, to use a plastic for the anti-rotation lock, which further simplifies the production by way of injection molding. In addition, it is possible to select a plastic which has an improved sliding ability so that a piston guide can be guided with little resistance in the anti-rotation lock.

Advantageously, the separate inner part is non-positively or positively connected to the brake caliper. The inner part is thus retained in the brake caliper without any further connecting means, which saves weight for connecting means. Advantageously, the non-positive connection is formed via an interference fit. Such connections are easy to form. It is also possible to establish a connection via positive-locking elements.

In a further advantageous example embodiment of the present invention, the drive motor is attached to the brake caliper. The drive motor is thus directly attached to the brake caliper. A separate housing for the drive motor is thus not required. This saves an additional working step for attaching a separate housing to the brake caliper.

According to an expedient example embodiment of the present invention, the region of the one-piece brake caliper to which the drive motor is attached comprises a plurality of mounting surfaces for the drive motor, which are aligned at different angles to one another so that the drive motor is attachable to the brake caliper in different mounting positions. The motor may be mounted on any of the mounting surfaces. Advantageously, the mounting surfaces are arranged distributed about an axis of rotation of the spindle drive. The mounting surfaces can be designed such that a polygon is formed on the brake caliper. Through the different mounting surfaces, the motor can be arranged according to the installation space available on the motor vehicle. As a result, only a single brake caliper must be provided, which is adaptable to different installation situations. The electromechanical brake can thus be used in a wide variety of ways so that development costs and production costs for different installation situations can be saved.

According to a further expedient example embodiment of the present invention, a drive gear cooperating with the spindle drive is arranged in the housing formed by the brake caliper. A separate drive gear housing is thus not required. As a result, a separate working step for attaching such a housing to the brake caliper can also be dispensed with. Weight for the necessary connecting means is also saved.

Preferably, a parking brake is arranged in the housing formed by the brake caliper. By forming a parking brake, the electromechanical brake additionally provides a parking brake function. As a result, a separate parking brake can be dispensed with.

Advantageously, according to an example embodiment of the present invention, a drive gear cooperating with the spindle drive is arranged in a gear housing arranged on the brake caliper. By forming the gear housing separately from the brake caliper, a material different from the brake caliper can be used for the gear housing. Since the load on the gear housing is significantly less than that on the brake caliper, a lighter and more cost-effective material can thus be used for the gear housing. By forming the gear in a separate housing, the brake caliper is also easier to produce.

The present invention also provides a motor vehicle comprising such an electromechanical brake according to the present invention. Such a motor vehicle has the above-described effects and advantages.

Embodiment examples of the present invention are shown in the figures and explained in more detail in the following description.

### BRIEF DESCRIPTION OF THE DRAWINGS

FIG. 1 shows a sectional view of an electromechanical brake according to a first embodiment example of the present invention.

FIG. 2 shows a sectional view of an electromechanical brake according to a second embodiment example of the present invention.

FIG. 3 shows a sectional view of an electromechanical brake according to a third embodiment example of the present invention.

FIG. 4 shows a section through the brake caliper of the electromechanical brake of FIG. 3.

FIG. 5 shows a perspective view of an embodiment example of the brake caliper of the present invention.

### DETAILED DESCRIPTION OF EXAMPLE EMBODIMENTS

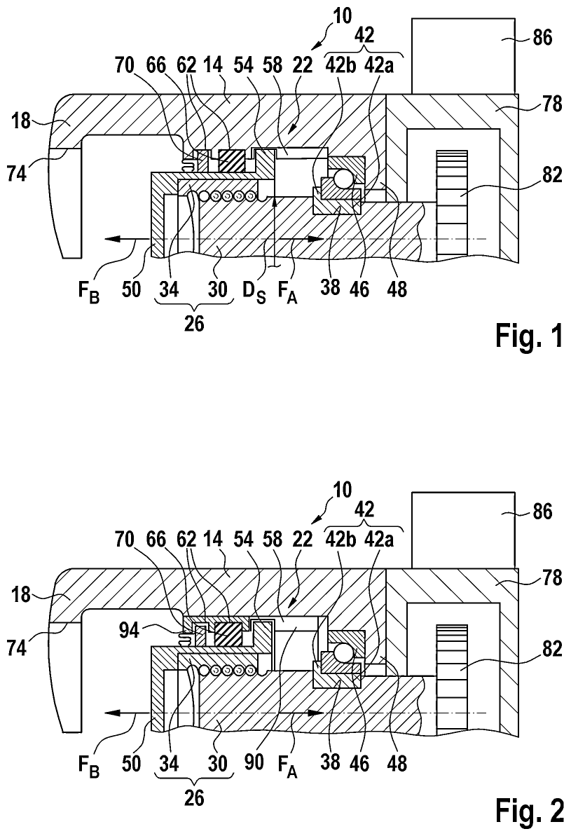

FIG. 1 shows a sectional view of an electromechanical brake 10 according to a first embodiment example of the present invention. The electromechanical brake 10 comprises a brake caliper 14, which forms a caliper body 18 and a housing 22. A spindle drive 26, which in this embodiment example is designed as a ball screw drive, is arranged in the housing 22. The spindle drive 26 comprises a spindle 30 and a spindle nut 34, which is axially displaceable with a rotation of the spindle 30.

The spindle 30 comprises a spindle ring groove 38, in which a support part 42 is arranged. The support part 42 has a cylindrical region 42a and a collar 42b projecting beyond an outer diameter D_{S} of the spindle 30. The cylindrical region 42a and the collar 42b abut against an angular contact ball bearing 46 arranged in the housing 22 of the brake caliper 14. The spindle 30 is rotatably mounted in the housing 22 via the support part 42 and the angular contact ball bearing 46. The angular contact ball bearing 46 is held in an axial direction via a radially inward-projecting axial support 48 of the brake caliper 14 so that a supporting force F_{A} counteracting a braking force F_{B} is absorbed by the brake caliper 14.

The spindle nut 34 is fixedly connected to a brake piston 50, via which the braking force F_{B} is appliable to a brake disk not shown. The braking force F_{B} applied by the brake piston 50 is absorbed via the caliper body 18 formed by the brake caliper 14.

In order to prevent the spindle nut 34 from rotating, the brake piston 50 forms radially extending rotation guides 54. The rotation guides 54 engage in anti-rotation locks 58 formed by the brake caliper 14. The anti-rotation locks 58 formed by the brake caliper 14 are designed as axially extending slots. The brake caliper 14 additionally forms ring grooves 62 for a piston seal 66 and a piston guide 70.

The caliper body 18 has a central cutout 74, via which the spindle drive 26 and the brake piston 50 can be mounted from the caliper body 18. A perspective view of the caliper body 18 with the cutout 74 is shown in FIG. 5. FIG. 1 additionally shows that a separate gear housing 78, in which a drive gear 82 for the spindle drive 26 is arranged, is attached to the brake caliper 14. In the embodiment example, the drive gear 82 is designed as a worm gear. For driving the drive gear 82 and thus the spindle drive 26, a drive motor 86 is arranged on the separate gear housing 78.

FIG. 2 shows a sectional view of an electromechanical brake 10 according to a second embodiment example of the present invention. This embodiment example differs from the embodiment example shown in FIG. 1 in that the anti-rotation lock 58 and the ring grooves 62 for the piston seal 66 and the piston guide 70 are not formed in the brake caliper 14. The anti-rotation lock 58 is formed by a separate inner part 90, which is inserted into the housing 22. The separate inner part 90 can be connected to the brake caliper 14 via an interference fit. The separate inner part 90 comprises the slot for the rotation guide 54 so that the brake piston 50 and thus the spindle nut 34 are secured against rotation. Additionally, in this embodiment example, a second inner part 94, via which the ring grooves 62 for the piston seal 66 and the piston guide 70 are formed, is arranged in the brake caliper 14. In a further embodiment example not shown, the two inner parts 90, 94 can also be embodied by a common inner part.

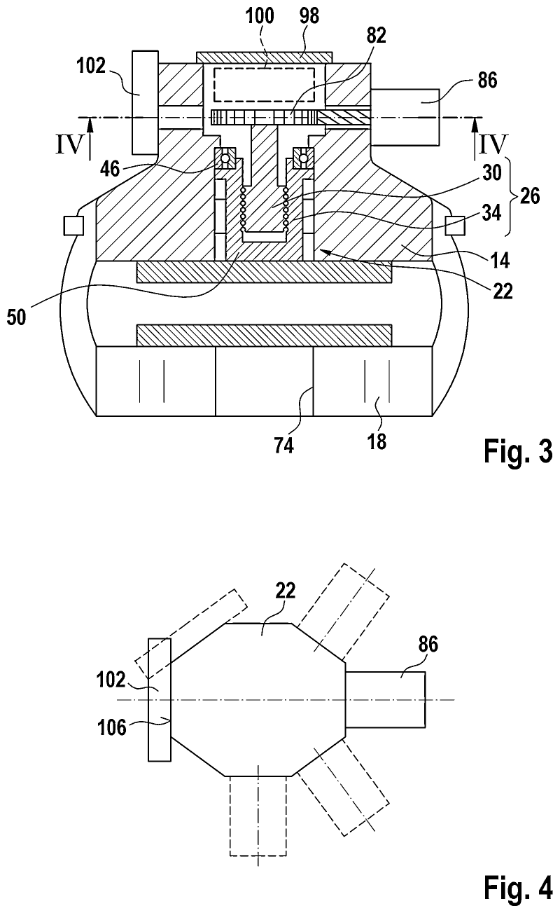

FIG. 3 shows a sectional view of an electromechanical brake 10 according to a third embodiment example of the present invention. This embodiment example differs from the embodiment examples of FIGS. 1 and 2 in that the drive gear 82 is not arranged in a separate gear housing 78. Rather, the gear housing 78 is formed in one piece by the brake caliper 14. The housing 22 for the drive gear 82 is closed only by a separate gear housing cover 98. A parking brake 100, which blocks the drive gear 82 during parking so that the brake can be held braked during the parking operation, is additionally arranged in the housing 22 for the drive gear 82. The drive motor 86 and a control unit 102 for the electromechanical brake 10 are arranged on the housing 22 formed by the brake caliper 14.

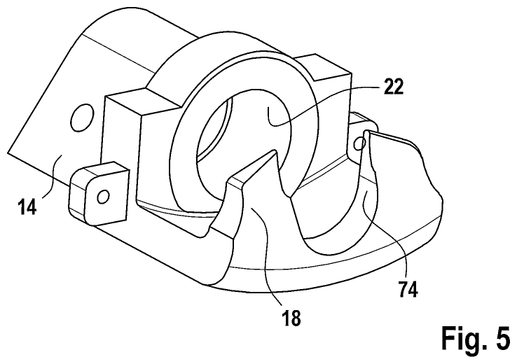

FIG. 4 shows a section through the brake caliper 14 of the electromechanical brake of FIG. 3. In this figure, it can be seen that the housing 22 for the drive gear 82 comprises a plurality of mounting surfaces 106 for the drive motor 86 and the control unit 102. The mounting surfaces 106 are aligned differently. Examples of how the drive motor 86 and the control unit 102 may also be arranged are drawn with dashes. The drive motor 86 and the control unit 102 can thus be arranged differently depending on the installation situation required. Various arrangements of the drive motor 86 and of the control unit 102 on the brake caliper 14 therefore require only one embodiment of the brake caliper 14.

What is claimed is:

1. An electromechanical brake for a motor vehicle, comprising:
a brake caliper forming a housing in which is arranged a spindle drive that is drivable via a drive motor so that a brake piston is movable for applying an axial braking force;
wherein the brake caliper is formed in one piece and forms not only an axial support for the spindle drive but also a caliper body so that the braking force and a supporting force counteracting the braking force are absorbed by the brake caliper.

2. The electromechanical brake according to claim 1, wherein the caliper body of the brake caliper has a cutout, via which the spindle drive and the brake piston are insertable into the housing formed by the brake caliper.

3. The electromechanical brake according to claim 1, wherein an anti-rotation lock for the spindle drive is formed by the brake caliper.

4. The electromechanical brake according to claim 1, wherein at least one separate inner part, via which at least one anti-rotation lock for the spindle drive is formed, is inserted into the brake caliper.

5. The electromechanical brake according to claim 4, wherein the separate inner part is non-positively or positively connected to the brake caliper.

6. The electromechanical brake according to claim 1, wherein the drive motor is attached to the brake caliper.

7. The electromechanical brake according to claim 6, wherein a region of the one-piece brake caliper to which the drive motor is attached comprises a plurality of mounting surfaces for the drive motor, which are aligned at different angles to one another so that the drive motor is attachable to the brake caliper in different mounting positions.

8. The electromechanical brake according to claim 1, wherein a drive gear cooperating with the spindle drive is arranged in the housing formed by the brake caliper.

9. The electromechanical brake according to claim 8, wherein a parking brake is arranged in the housing formed by the brake caliper.

10. The electromechanical brake according to claim 1, wherein a drive gear cooperating with the spindle drive is arranged in a gear housing arranged on the brake caliper.

11. A motor vehicle, comprising:
an electromechanical brake, including:
a brake caliper forming a housing in which is arranged a spindle drive that is drivable via a drive motor so that a brake piston is movable for applying an axial braking force,
wherein the brake caliper is formed in one piece and forms not only an axial support for the spindle drive but also a caliper body so that the braking force and a supporting force counteracting the braking force are absorbed by the brake caliper.
